(19) United States
(12) Patent Application Publication
(10) Pub. No.: US 2006/0271485 A1
(43) Pub. Date: Nov. 30, 2006

(54) Wireless connectivity security technique

(75) Inventors: Kevin McKenzie, El Dorado Hills, CA (US); Nihad Hafiz, Ladera Ranch, CA (US); Craig Lurey, El Dorado Hills, CA (US)

Correspondence Address: Rupak Nag, 4406 Oakland Ave., Minneapolis, MN, 55407, US

(73) Assignee: JiWire, Inc.

(21) Appl. No.: 11/375,695

(22) Filed: Mar. 13, 2006

Related U.S. Application Data
(60) Provisional application No. 60/661,056, filed on Mar. 12, 2005.

(51) Int. Cl. G06Q 99/00

(52) U.S. Cl. 705/51

(57) ABSTRACT

Methods and systems are described for providing security for data being transmitted from a device at a public Wi-Fi enabled zone (e.g. a Wi-Fi Hotspot) to a destination on the Internet. Methods and systems are also described for enabling users to send e-mail from these zones and bypassing outgoing e-mail blocks enforced by WISPs. Data are encrypted either entirely or partially on the device by a security application resident on the device. The encrypted data are sent out via a dedicated port on the device. The security application controls this port and closes all the other ports. The encrypted data are transmitted via a wireless Wi-Fi signal to a network component, such a router or other access point. From there the data are transmitted over the Internet to a security server controlled by a Wi-Fi security provider. There they are decrypted and forwarded to a destination. If the data are an e-mail message, the decrypted data are transmitted to an e-mail relay server also under the control of a Wi-Fi security provider. From there it is forwarded to a destination e-mail server.

### CROSS-REFERENCE TO RELATED APPLICATIONS

This application claims priority under 35 U.S.C. section 119 to Provisional Patent Application No. 60/661,056, titled “A Method and System for Providing Security During Data Transmission over Wireless and Wired Network Connections” filed Mar. 13, 2005, assigned to JiWire, Inc., and hereby incorporated in its entirety for all purposes.

### BACKGROUND OF THE INVENTION

1. Field of the Invention

The present invention relates generally to computer network security. More specifically, it relates to computer software and network components for ensuring data security over wireless connections in public spaces.

2. Introduction

Public Wi-Fi access, although still in its infancy, is an increasingly common way for connecting to the Internet in public places via a wireless connection. It is estimated that there are over 100,000 Wi-Fi zones in over 120 countries. These areas, also referred to as “Hotspots,” enable a user to obtain access to the Internet, in many cases via a high-speed, broadband connection. In a typical scenario, a user connects to the Internet via a notebook with wireless capability or other wireless IP-enabled device by accessing a router or access point in the public space, such as a cafe, airport, hotel, library, etc., or other Wi-Fi enabled zone, the access point component is owned or operating by an entity responsible for maintaining the zone. Internet access is provided by a wireless Internet service provider (“WISP”). Before the user can access the Internet, the user must first connect to the access point or router via a wireless connection using a Wi-Fi signal.

There are, however, significant security issues. One is that the access point or router owner at the public Wi-Fi zone is typically not known to the user and thus the user is typically connecting in a highly insecure manner with regard to the wireless connection from the device, such as a notebook computer, to the access point. This is a highly vulnerable connection, especially in crowded Wi-Fi zones, such as a busy cafe or airport terminal.

Data transmitted between the notebook or other wireless device and the access point are typically unprotected and vulnerable to interception. Sensitive information such as e-mail passwords and content, personal information, credit card information, instant message content, file server logins, and so on can be intercepted by network “sniffers”, via rogue access points (“evil twins”), via “stumbling” software, and network “crackers”, among other known techniques.

Although virtual private network (VPN) software is available to secure some data sent from public Wi-Fi locations, as a practical solution, use of such VPNs is limited to employees of corporations or other entities that have sophisticated IT support and have trained its employees to use the relatively complex VPN software. Use of such software is not a feasible security solution for the average user.

Another issue faced by users of public Wi-Fi is the inability to send e-mails over the Internet. A user can generally download e-mails, for example, via an e-mail client such as Outlook or Group Wise, but cannot send e-mails. E-mail transmissions are typically blocked by the WISP. The issue arises from unauthorized parties intercepting e-mails and creating mass unsolicited e-mails, or spam, using the WISP's e-mail relay servers and other known techniques. By blocking outgoing e-mails, spammers are prevented from taking advantage of security loopholes and sending mass unsolicited e-mails without being traced or identified.

Consequently, by having e-mails blocked, one of the main advantages of getting online at public Wi-Fi locations is significantly hampered given that a large majority of users get online to send and receive e-mails. There is presently no solution for the average user to bypass the blocking of Internet e-mail from public WiFi access points by WISPs.

There lacks a comprehensive solution for a non-technical user not using a corporate or professional VPN or similar software to securely use a public WiFi connection for accessing the Internet and performing routine activities such as transmitting e-mail and downloading data from Web sites. What is needed is an application that a user can install on a IP-enabled wireless device that enables the user to securely access the Internet so that unauthorized users are unable to read unencrypted content and that allows users to send e-mails from public Wi-Fi enabled zones.

### SUMMARY OF THE INVENTION

One aspect of the present invention is a method of providing security for data being transmitted from a device at a public Wi-Fi enabled zone to a destination on the Internet. The type of data that can be transmitted according to the present invention falls into two general categories: e-mail data and non e-mail data. In each case, data are encrypted either entirely or partially on the device by a security application resident on the device. The encrypted data are sent out via a dedicated port on the device. In one embodiment, the security application controls this port and doses all the other ports. The encrypted data are transmitted via a wireless Wi-Fi signal to a network component, such a router or other access point. From there the data are transmitted over the Internet to a security server controlled by a Wi-Fi security provider. There they are decrypted and forwarded to its destination. If the data are e-mail messages, the decrypted data are transmitted to an e-mail relay server also under the control of a Wi-Fi security provider. From there they are forwarded to a destination e-mail server.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a network diagram illustrating the basic configuration of a Wi-Fi connection between a wireless device, such as a notebook computer, and a security server of the present invention.

FIG. 2 is a flow diagram of an overview of a Wi-Fi security process of the present invention.

FIG. 3 is a block diagram showing components of a Wi-Fi security application resident on a device in accordance with one embodiment of the present invention.

FIG. 4 is a screenshot of a user interface for accessing the Wi-Fi security process of the present invention.

FIG. 5 is a flow diagram of a process of transmitting data from a device in a Wi-Fi zone to a destination on the Internet in accordance with one embodiment of the present invention.

### DETAILED DESCRIPTION OF THE PREFERRED EMBODIMENT

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Methods and systems for securely transmitting and receiving data on a wireless IP-enabled device at a Wi-Fi enabled zone are described in the various figures. The present invention allows a user to create a highly secure link between the user's wireless device and a security server operated by a third-party Wi-Fi security service provider. The secure link can be described as a “tunnel” in which the user's data travels thereby protecting the data from harmful or malicious interception and enables e-mail data to bypass blocking mechanisms.

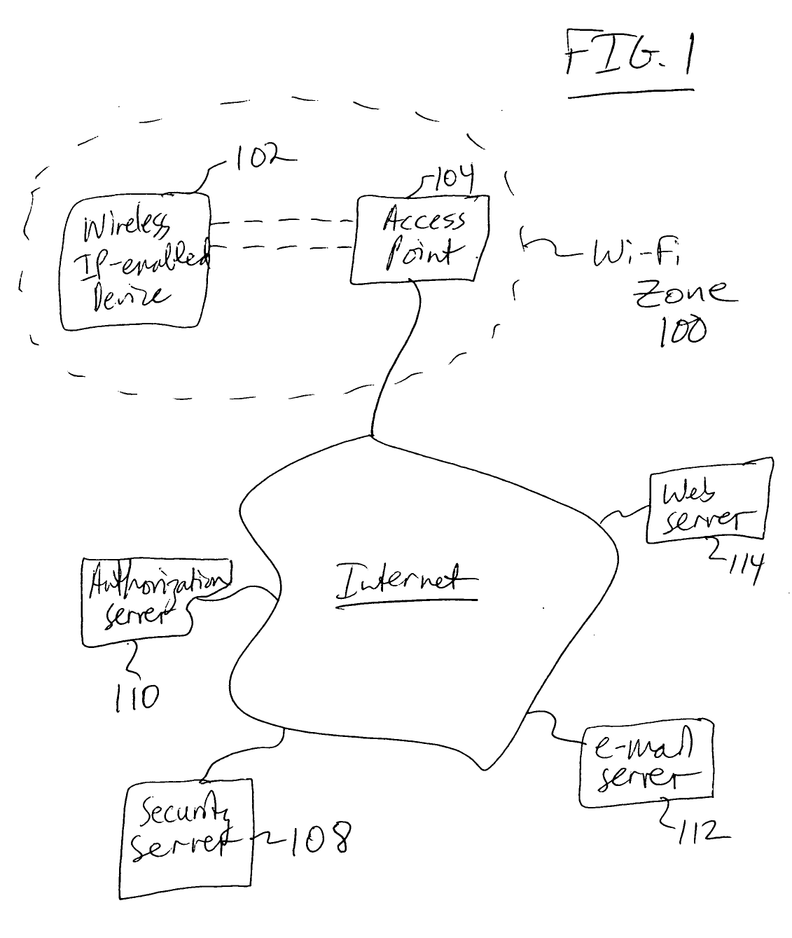

FIG. 1 is a network diagram illustrating the basic configuration of a Wi-Fi connection between a wireless device, such as a notebook computer, and a security server of the present invention. A notebook computer 102 is connected to an access point or router 104 via a wireless connection 106 at a Wi-Fi enabled zone 100 that provides free public Wi-Fi access.

Router 104 is connected to the Internet via a wired connection such as an Ethernet connection. One or more security servers 108 are connected to the Internet as is authorization server 110, both under the operation of a third-party Wi-Fi security provider (hereinafter “Provider”). To illustrate the present invention, also shown are an e-mail server 112 operated by a public e-mail provider and a Web server 114 capable of providing Web content. In a preferred embodiment, there are numerous security servers 108 strategically located at various geographic locations for efficient response time and load balancing to off-set heavy loads on specific servers and equalize bandwidth. This is also true for the authorization server 110. In addition, at location 100, there may be more than one access point or router 104 and numerous wireless IP-enabled devices connecting to router 104 typically under control of the entity operating the Wi-Fi enabled zone. The primary entities involved in a typical Wi-Fi environment and connection are the user taking advantage of the free Wi-Fi a WISP that provides actual Internet access for the user (every public Wi-Fi or Hotspot has a WISP), a Provider, and Web content and e-mail providers.

The present invention provides a point-to-point Wi-Fi security mechanism-a data tunnel-between one or more designated ports on wireless device 102 and a port on security server 108 operated by a Provider. When a user establishes Wi-Fi security utilizing the present invention, all data transmitted between wireless device 102 and security server 108 are encrypted. In a preferred embodiment, the encryption technology used is IPSec, a commercially available encryption technique that provides a high degree of data scrambling. IPSec provides a secure gateway-to-gateway connection across outsourced private wide area networks or Internet-based connections using L2TP/IPSec tunnels or pure IPSec tunnel mode. IPSec defines IP packet formats and related infrastructure to provide end-to-end strong authentication, integrity, anti-replay, and confidentiality for network traffic. In other preferred embodiments, other encryption routines such as PPP, can be used without modifying or altering the concepts of the present invention. Before describing in detail the processes and components necessary for implementing the present invention, it is useful to describe a general overview of the inventive process.

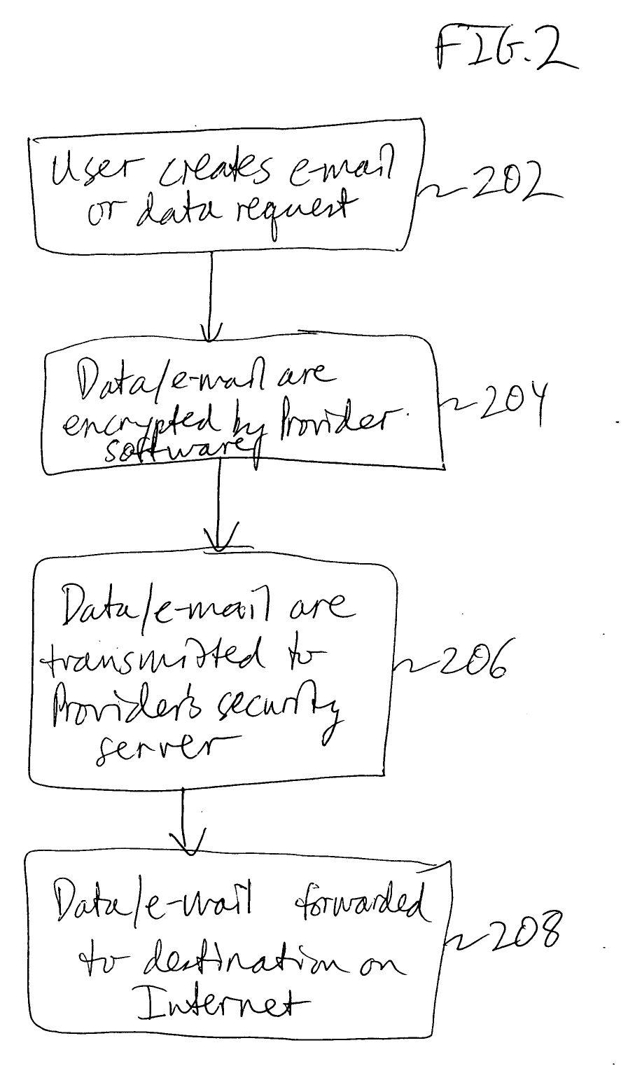

Assuming a user has previously registered with the Provider operating the Wi-Fi security processes and components of the present invention, and has logged on as an authorized user, at step 202 of FIG. 2, a user composes e-mail or a request for data and attempts to transmit these data from wireless device 102 at a Wi-Fi location 100. As described below, these data can be HTTP requests, e-mail messages, instant message data, VoIP data, and so on.

At step 204, the data are encrypted by the Provider on wireless device 102 using software resident on the device and previously supplied by the provider and installed by the user. The encrypted data are sent from the device to an access point, router, or other suitable component at Wi-Fi location 100. The salient point is that the connection is wireless and vulnerable to intrusion or detection by other users at location or zone 100.

At step 206 the encrypted data are sent from the access point over the Internet to security server 108 rather than to its final destination, such as an e-mail server or a Web server. At server 108, the data are decrypted by the Provider at step 208 and are transmitted unencrypted to the intended final destination at which point the data transmission process is complete. A similar process takes place for certain types of data being returned to wireless device 102 in response to data originally transmitted. For example, if the request is an HTTP or FTP request, a Web page or file is sent to security server 108. The page or file is then encrypted at security server 108 and transmitted back to the wireless device via the data “tunnel” of the present invention. The wireless device receives the encrypted data and decrypts the data using the Wi-Fi security application software supplied by the Provider, described in further detail below.

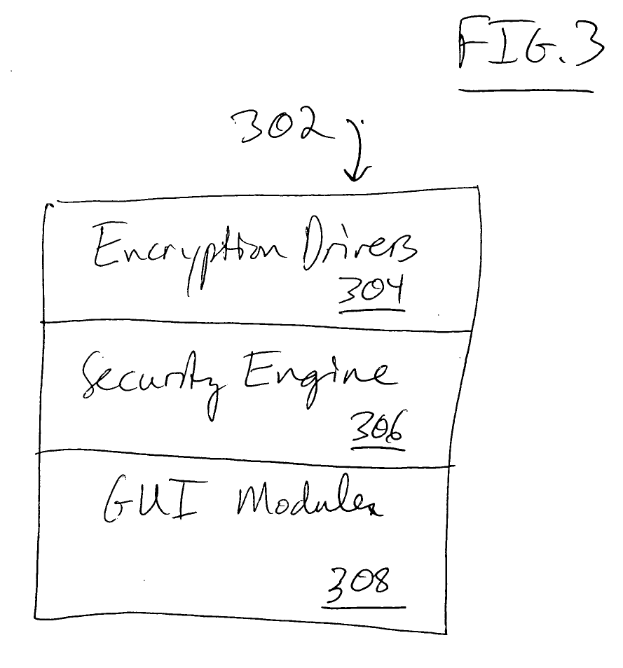

FIG. 3 is a block diagram showing functional modules and software components in a Wi-Fi security application that resides on a wireless device in accordance with one embodiment of the present invention. Security application 302 is downloaded from the Provider and installed by the user on a wireless device that the user intends to use at public Wi-Fi enabled zones. It includes encryption drivers 304, a security engine 306, and a graphical user interface module 308, among other components.

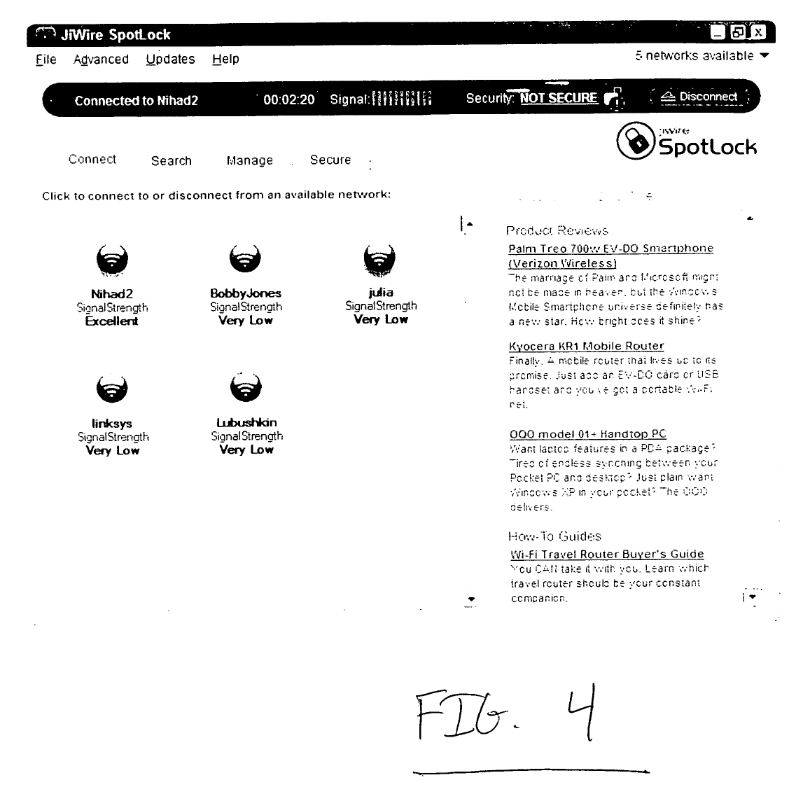

In a preferred embodiment, the encryption technology is IPSec and, thus, drivers 304 are IPSec drivers that are able to encrypt and decrypt data. As is known in the field of encryption, IPSec is comprised of a combination of drivers that can encrypt data. In this case the encrypted data are transmitted from a particular port as described below. GUI module 308 implements a user interface that allows the user to select the security option when logging on to the Internet from a public Wi-Fi zone and allows the user to select other functions enabled by the provider, e.g., finding a Wi-Fi location. A sample screenshot is shown in FIG. 4. The GUI can also be used to activate, de-activate, and manage an account.

Security application 302 also contains software modules for “converting” data in an original protocol, such as HTTP, to Uniform Datagram Protocol (UDP). Security application 302 contains drivers, scripts, and executable code that enables the opening of a particular port for transmitting and receiving data while blocking all other ports, except for port 25 for e-mails. In this respect, security application 302 functions as a “personal Wi-Fi” firewall for the wireless device. In addition to those listed above, security application 302 contains other drivers and software components to execute the functions needed to implement the present invention. For example, security application 302 has a layer of drivers to address a vast array of hardware configurations, relevant with respect to opening a designated port and communicating with external components. The selection, design, and coding of security application 302, including the various drivers, can vary based on the type of wireless device (e.g., “smart phone” vs. laptop computer) and the degree of functionality the Provider decides to offer. This selection, design, and coding can be done by someone of ordinary skill in the field of wireless communications and encryption.

The security server of the present invention is a type of VPN server that is specifically for Wi-Fi security. The VPN software establishes a virtual network between the wireless device and the security server. One of the primary characteristics of the VPN software executing on the security server of the present invention is its ability to block ports on a client (in this context, the wireless device) and maintain and control only specific ports.

This “port-specific” VPN software of the present invention can use other types of encryption technology, such as PPP encryption or others. Selection of a specific technology does not modify or supplant the concepts of the present invention. The Provider can use any suitable encryption technology in creating VPN software to execute on the security server. The IPSec libraries utilized on the security server are commercially available. Of course, drivers for the same encryption technology must also be present in Wi-Fi security application 302 residing on the wireless device.

Typically, there are two primary activities users perform while using Wi-Fi. These activities correlate directly to two general categories of data that are transmitted from wireless devices. One category is e-mail. This covers a large majority of the activity users would perform using public Wi-Fi if it were not for e-mail blocking as described above. E-mails sent using public Wi-Fi are typically blocked by the WISPs to prevent spammers from taking advantage of security loopholes involving relay servers for e-mail and sending mass unsolicited e-mails without being traced or identified. This includes sending e-mail from a e-mail service provider, such as Yahoo, Earthlink, Hotmail, GMail, and so on. Another way people send e-mail is using an e-mail client such as Outlook from Microsoft or GroupWise from Novell.

The other category of data includes essentially all other types of requests, a large majority of which are requests based on Hypertext Transfer Protocol (HTTP) and, to a lesser extent, on File Transfer Protocol (FTP). HTTP requests include nearly all requests to download data from a Web site onto the user's browser. The methods and components for implementing the present invention are distinguishable based on which category of data is being transmitted from the wireless device.

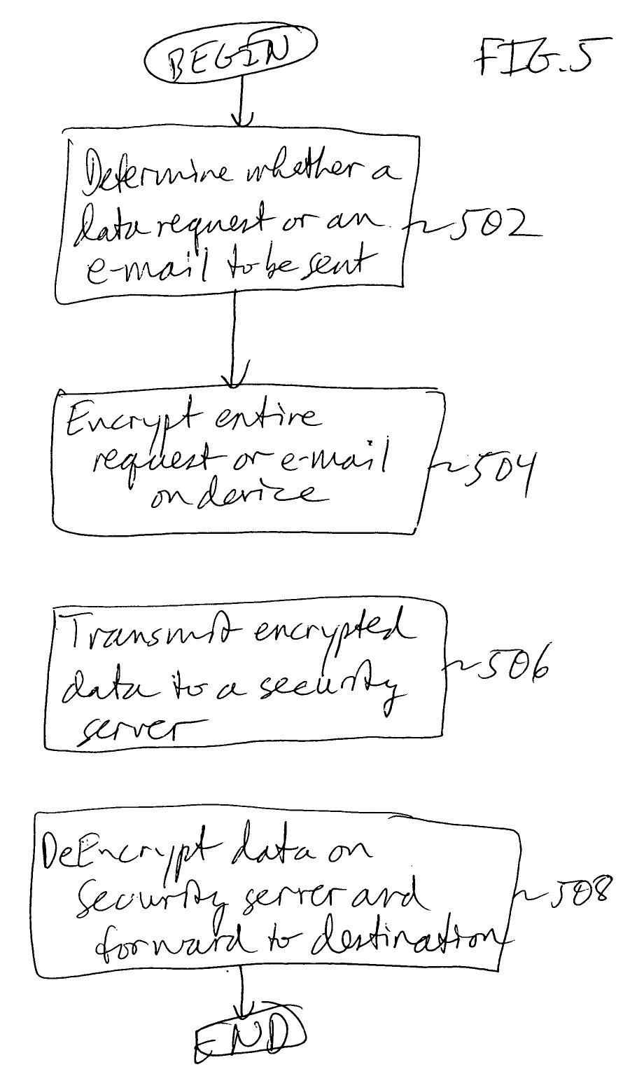

FIG. 5 is a flow diagram of a process in which data (non e-mail) requests are securely transmitted from a wireless device to an access point or router at a public Wi-Fi location and over the Internet in accordance with one embodiment of the present invention. At step 502 security application 302 determines that a request for data is being made and determines through which port on the wireless device the request will be transmitted. One of the functions of security application 302 is to select and open a port on the device that will be used to transmit data and to close ports that will not be used. Some ports are reserved for certain functions, such as port 80 for HTTP requests, port 25 for Simple Mail Transfer Protocol (SMTP), port 21 for FTP requests, and so on. As is known in the field of network programming, an application can utilize a port that is not reserved for any function and make it the default or “designated” port for all input and output of data managed by that particular application. It can also close all other ports. In a preferred embodiment, application 302 and specifically IPSec drivers 304, select a port for data transmission and close all others except port 25 for e-mails. All data going out of the designated port are transmitted to the Provider's security server.

At step 504, the entire request, including the header, URL, cookies, and so on, is encrypted. In other preferred embodiments, only portions of the data request are encrypted. At step 506, the encrypted data are sent to the security server. The security server knows it is receiving a request because it was transmitted from the designated port. At step 508 the security server decrypts the data packets and forwards to the final destination.

As is known in the field of network application programming, the User Datagram Protocol/Internet Protocol (UDP/IP), can be used to facilitate transmission of data between a client and server and is capable of handling all types of data traffic. One feature of UDP/IP that makes it suitable for a preferred embodiment of the present invention is its lack of error recovery services (such as those provided in TCP/IP) and the accompanying overhead that comes with providing these services. These services are not needed in the present invention mainly because data are being sent to and received from a known server, namely, security server 302 or an authentication server, both under control of the Wi-Fi security service Provider.

The other type of data that users typically attempt to transmit from a wireless device is e-mail data. These steps are similar as those described above. In a preferred embodiment, the entire content of an e-mail is encrypted at the wireless device using IPSec or other encryption technology.

When e-mails are transmitted from the wireless device, instead of transmitting the encrypted data packets from the designated port, the data packets are sent using SMTP port 25. Security application 302 keeps this port open and controls it specifically for transmitting e-mails, instead of using the designated port that is used for all other data transmissions. The security server is able to determine that an e-mail message is being received based on header information after the packets have been decrypted. Given that it has received an e-mail message it immediately forwards the e-mail data to an SMTP e-mail relay server under control of the Provider. The e-mail is then sent to the final destination e-mail server. In a preferred embodiment, a reply is sent directly to the wireless device via port 25. In other embodiments, a reply to the e-mail is sent to the wireless device through the security server where it is encrypted and decrypted at the wireless device.

During the user logon process, the Provider determines the location of the user based on the user's IP address which is transmitted to the Provider's authentication server to verify the user. The user's IP address is assigned by a WISP at the public Wi-Fi location where the user is logging on. This information is then used by the Provider to select which of numerous security servers the encrypted data packets should be sent.

Factors other than location, such as the current load on each security server, are also used to determine which security server will be used to handle the Wi-Fi security for the user. General load balancing techniques can be used to determine which security server should be used. In a described embodiment, any of the security servers maintained by the provider can be used to handle security for a user. The selection of a particular server is transparent to the user except for small differences the user may experience in latency if a less efficient or non-optimal server is selected.

The authentication server can authenticate a user based on device serial number, MAC address, or password. In a preferred embodiment, during the logon process, data transmitted from the wireless device to the authentication server, such as username, password, MAC address and so on, are encrypted. If the user is verified and authenticated, data transmitted back to the user (e.g., message telling user that logon was successful) is encrypted, thus a point-to-point tunnel is established In the described embodiment, if the user is not authenticated, the message sent back to the user is not encrypted and Wi-Fi security is not established.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A method of transmitting data from a wireless device to a destination on the Internet, the method comprising:
forming a request for data on the wireless device;
encrypting the request;
transmitting the encrypted request via a Wi-Fi signal to an access point;
transmitting the encrypted request from the access point to a security server;
decrypting the request at the security server; and
forwarding the decrypted request to the destination.

2. A method of transmitting an e-mail message from a wireless device to a destination on the Internet, the method comprising:
forming an e-mail message on the wireless device;
encrypting the e-mail message;
transmitting the encrypted e-mail message via a Wi-Fi signal to an access point;
transmitting the encrypted e-mail message from the access point to a security server;
decrypting the e-mail message at the security server;
transmitting the decrypted e-mail message from the security server to an e-mail relay server; and
transmitting the e-mail message from the relay server to the destination.

3. A method of securely transmitting data from a device at a Wi-Fi enabled zone to a destination on the Internet, the method comprising:
on the device, encrypting data to be transmitted;
transmitting via a Wi-Fi connection the encrypted data to the Intenet;
at a security server, receiving the encrypted data and decrypting the data;
transmitting the decrypted data to the destination.

4. A method as recited in claim 3 further comprising:
at the security server, receiving response data from the destination;
encrypting the response data;
transmitting the encrypted response data to the device; and
decrypting the response data on the device.
